(19) United States
(12) Patent Application Publication
(10) Pub. No.: US 2026/0071863 A1
(43) Pub. Date: Mar. 12, 2026

(54) STANDING TURF INFILL DEPTH TESTER WITH WEIGHTED DEPTH OPTION

(71) Applicant: NIKE, Inc., Beaverton, OR (US)

(72) Inventor: Robert P. SIMPSON, Newburg, OR (US)

(73) Assignee: NIKE, Inc., Beaverton, OR (US)

(21) Appl. No.: 18/882,340

(22) Filed: Sep. 11, 2024

(51) Int. Cl. G01B 3/20; G01B 3/28

(52) U.S. Cl. CPC G01B 3/205; G01B 3/28

(57) ABSTRACT

A device may include a shaft including a first distal portion and a second distal portion opposite the first distal portion. A device may include a handle extending from the shaft proximate the first distal portion of the shaft. A device may include a digital read out display proximate the first distal portion of the shaft. A device may include a caliper disposed at the second distal portion of the shaft. A device may include a weight flange disposed at the second distal portion of the shaft and operatively connected to the caliper, wherein the weight flange is configured to move in a direction parallel to the shaft and the caliper.

### TECHNICAL FIELD

The present invention relates in general to turf infill testers, and more particularly, to standing infill depth testers with weighted depth options.

### BACKGROUND

This section provides background information related to the present disclosure which is not necessarily prior art.

Various turf infill depth testers are available. However, most turf infill testers are small and require a user to bend over to take each measurement. In addition, the measurements were either not displayed or displayed but only for a short period of time and hard to read.

### SUMMARY OF THE DISCLOSURE

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts an exemplary turf infill depth tester, according to one or more embodiments.

FIG. 1B depicts an exemplary turf infill depth tester, according to one or more embodiments.

FIG. 2A depicts an exemplary turf infill depth tester, according to one or more embodiments.

FIG. 2B depicts an exemplary turf infill depth tester, according to one or more embodiments.

FIG. 3 depicts a top view of an exemplary turf infill depth tester, according to one or more embodiments.

FIG. 4 depicts an exemplary system for use with a turf infill depth tester, according to one or more embodiments.

FIG. 5 depicts an exemplary flow diagram, according to one or more embodiments.

FIG. 6 depicts an exemplary flow diagram, according to one or more embodiments.

### DETAILED DESCRIPTION OF EMBODIMENTS

The present disclosure describes turf infill depth testers providing a standing and weighted option. The standing turf infill depth tester may allow for a user to stand upright during infill depth measurements. Standing during measurements may allow for ease of operation compared to conventional turf infill depth testers. The turf infill depth tester with weighted option may allow for more accurate compactness infill depth measurements compared to conventional turf infill depth testers.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “disposed,” or “extending from,” another element or layer, it may be directly on, engaged, connected, coupled, disposed, or extending to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. When an element or layer includes the directional and/or spatial term (e.g., top, bottom, medial, lateral, etc.), the directional and/or spatial term is used relative to when the infill depth tester is upright on a flat, level surface. The device may be otherwise oriented (rotated 90 degrees or at other orientations) and the spatially relative descriptors used herein interpreted accordingly.

In the discussion that follows, terms “about,” “approximately,” “substantially,” and the like, when used in describing a numerical value, denote a variation of +/−10% of that value, unless specified otherwise.

Infill depth measurement is an important component of artificial turf installation, a type of playing surfaces widely used by American football and global football. During installation of artificial turf, green carpet of plastic fibers may be laid down onto a flat surface. A mixture of ground rubber pellets and sand called infill may then be poured and worked in between the grass fibers. The depth of this mixture may be important in the performance and safety of artificial turf, such that turf manufacturers have strict infill depth specifications that must be met due to rising concerns of player safety of turf traction. Despite turf manufacturers having strict infill depth specifications, variability in turf performance with cleat and field interactions still exists due to infill depths changing over time.

Known infill depth testers are short and require bending over or kneeling on the ground to test and take measurements along with small and hard to read displays. However, designing a standing infill depth tester may allow for a user to stand while taking measurements. In addition, including a digital display, rather than small granulated lines, provides for better and more accurately read measurements. A T-handle design allows for better stability and leverage when taking measurements. Additionally, including a weighted infill depth option adds the advantage of weighted measurements.

Variability in turf performance with cleats and field interaction exists in turf despite infill depth measurement within specifications of manufacturers. This has been observed through years of testing in the Nike® lab using a tester designed to test cleats in various movements at potentially injurious loads in artificial turf to look at how quickly a shoe will “release” and potentially prevent an injury from occurring. “Release” refers to a shoe moving beyond a specific displacement and dropping below a specific force or torque. Because results may vary significantly between different spots of the same turf at the same infill depth, there may be desire to find or create a new measurement to get more consistent turf.

An area of concern in artificial turf is compaction. Over time, the infill mixture may become more and more compacted from the original installation due to use, exposure to the elements and other variables. As the turf becomes compacted, field managers may add more infill to maintain the infill depth specification. Over time, despite the infill depth being maintained within specification, the more densely compacted turf may cause changes in turf performance from the original installation or design. There is currently no tool on the market that can measure infill depth compaction or density.

A weighted flange may have the ability to add weights (e.g., Olympic-sized weights with a hole diameter of about 50 mm). Adding weights may allow the weighted flange to push the pin flange into the turf to get more compacted readings. The ratio of the unweighted to weighted infill depth may assist in describing the compaction of infill depending on the amount of weight used. For example, a new turf with little compaction may have a large difference in the unweighted and weighted infill depth, whereas an old compacted turf may measure close to the same. This ratio or difference may better assist field managers make more consistent turf for game day which may help in reducing player injury.

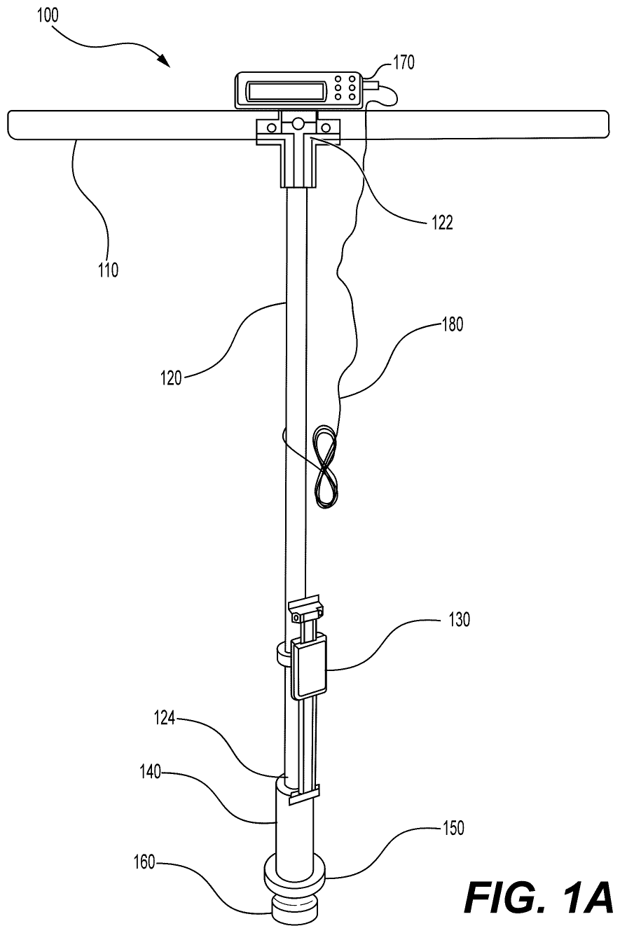

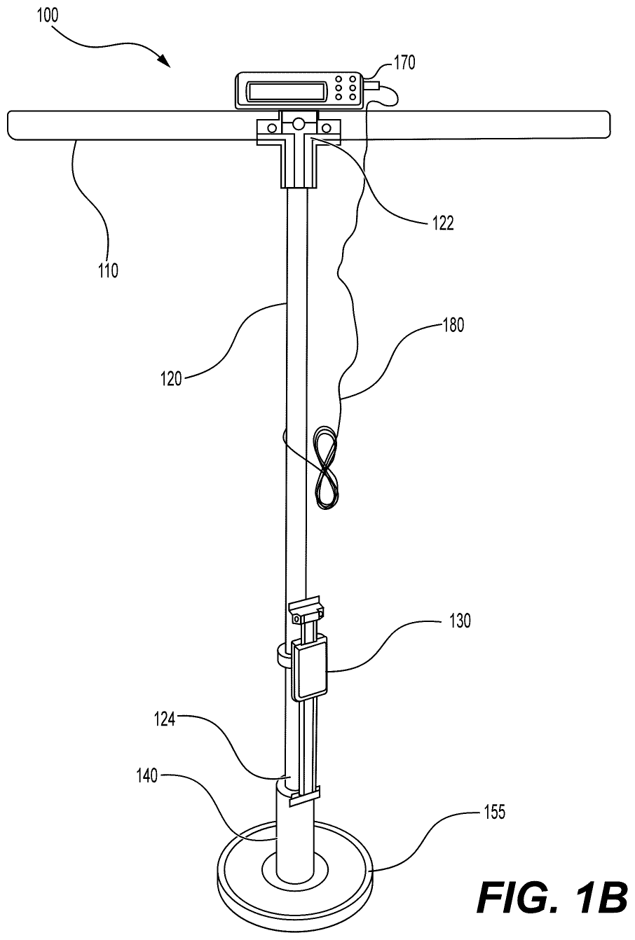

FIG. 1A depicts an exemplary turf infill depth tester, according to one or more embodiments. Infill depth testing device 100 may include a handle 110, a shaft 120, a caliper 130, a weight flange 140, and a digital read out display 170. The shaft 120 may include a first distal portion 122 and a second distal portion 124 opposite the first distal portion 122. The shaft 120 may be adjustable to different lengths depending the user preferences. The shaft 120 may include an adjusting mechanism (not shown) to change the length of the shaft 120 extending between the first distal portion 122 and the second distal portion 124. The adjustment mechanism may be proximate to the first distal portion 122 of the shaft 120, proximate to the second distal portion 124 of the shaft, or disposed at another location on the shaft 120. Material of the shaft 120 may include metal (e.g., aluminum, titanium, or iron), alloys, or a combination thereof.

The handle 110 may extend from the shaft 120 proximate the first distal portion 122 of the shaft 120. The handle 110 may be adjustable to different lengths depending the user preferences. The handle 110 may include an adjusting mechanism (not shown) to change the length of the handle. The adjustment mechanism may further allow for offsetting the handle 110 with respect to the shaft 120 (e.g., length of the handle 110 on either side of the adjustment mechanism, angle of the handle 110 relative to the shaft 120, etc.), providing further customization of the handle 110. The handle 110 may include another adjustment mechanism (not shown) to adjust the angle of the handle 110 relative to the shaft 120. In addition, the adjustment mechanism may allow the handle 110 to fold. Material of the handle 110 may include metal (e.g., aluminum, titanium, or iron), alloys, or a combination thereof. Either of the adjustment mechanisms described above may be located in proximity to the first distal portion 122 of the shaft 120.

The weight flange 140 may be disposed at the second distal portion 124 of the shaft 120 and operatively connected to the caliper 130. The weight flange 140 is used to determine an infill depth measurement upon placement of the weight flange 140 atop a surface while pushing down on the handle 110, as further described below. The digital read out display 170 may be proximate the first distal portion 122 of the shaft 120. The caliper 130 may be disposed at the second distal portion 124 of the shaft 120.

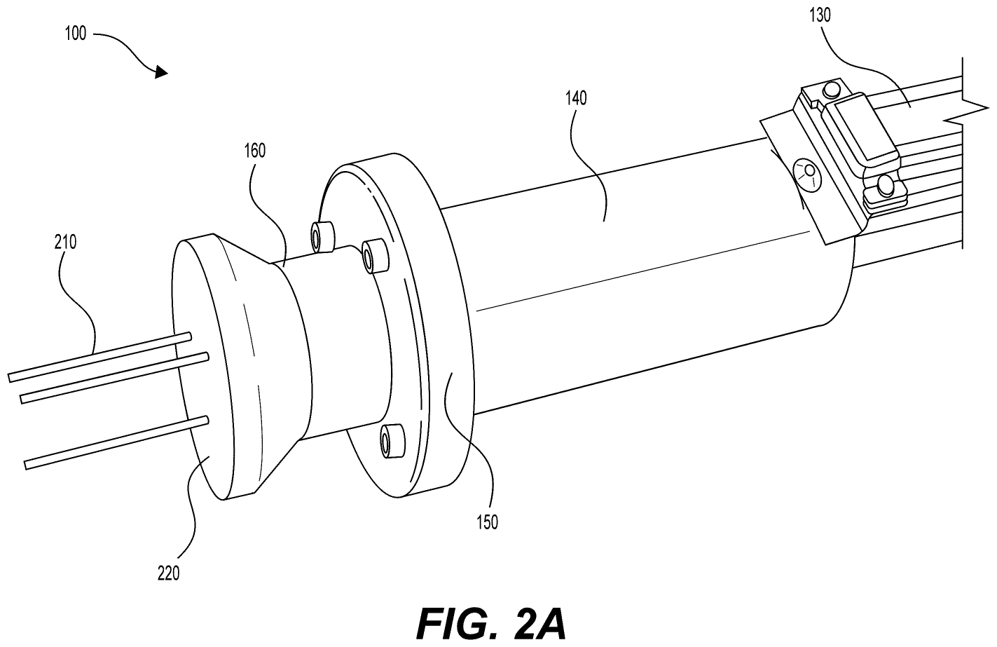

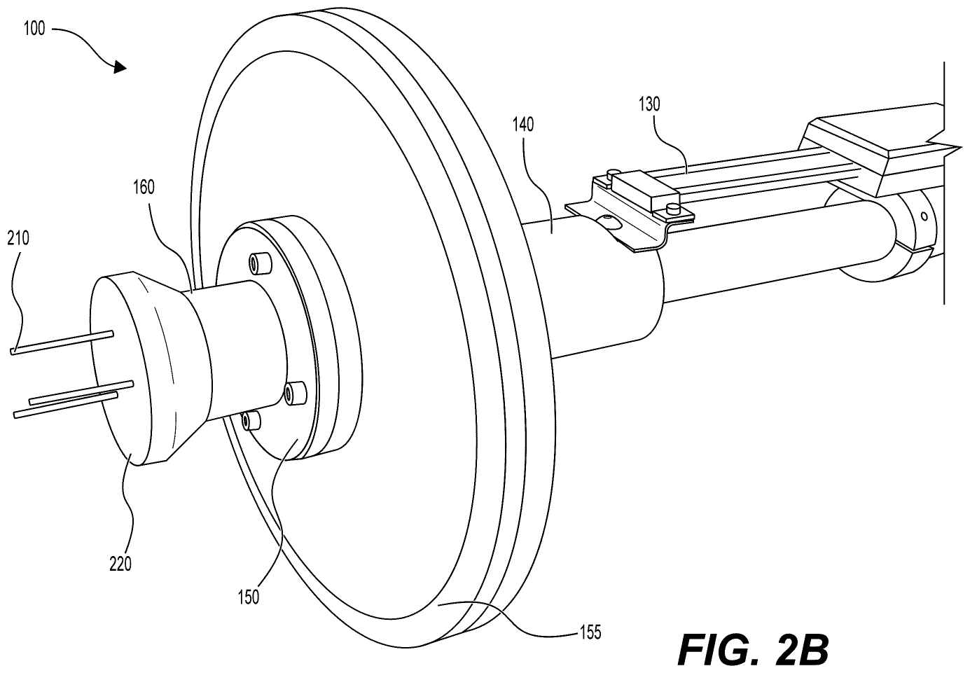

The weight flange 140 may include a weight mount 150 and a pin flange 160. The weight mount 150 may be configured to hold at least one weight. For example, a 20 pound weight may be added to the infill depth testing device 100. However, any number of weights (e.g., two or three) and any amount of weight (e.g., between 5 pounds and 50 pounds) may be added to the weight mount 150 based on the requirements or needs of the application and use. The weight flange 140 may be configured to determine an infill depth measurement with or without a weight placed on the weight mount 150 as further described below. The pin flange 160 may include a plurality of pins (see FIG. 2A and FIG. 2B) disposed parallel to the pin flange 160 that may extend in a distal direction as further described below. The infill depth testing device 100 may include a connection 180 operatively connected to the digital read out display 170 and the caliper 130. The connection 180 may be configured to transmit an infill depth measurement from the caliper 130 to the digital read out display 170. The connection 180 may include at least one of a wired or wireless connection. Wired connections may include, but are not limited to, Ethernet, fiber optics, coaxial cables, etc. Wireless connections may include, but are not limited to, Bluetooth®, Wi-Fi, infrared, Wireless WAN, etc.

Digital read out display 170 may be configured to display the infill depth measurement using either metric units (e.g., millimeters) or imperial units (e.g., inches). The digital read out display 170 may be configured to display the infill depth measurement to a one-hundredth decimal place (e.g., two decimal places). The digital read out display 170 may be configured to have an adjustable illuminated display. For example, the user may set the brightness of the display, and/or the frequency or timing of the illumination (e.g., always on, always off, or turn on when a measurement is determined). The digital read out display 170 may be configured to display a notification of the infill depth with respect to infill specifications (e.g., a predefined range) of the artificial turf. The notification may alert a user (e.g., visual and/or audible alert) to the infill depth measurement being within and/or outside the predefined range. Additional notifications from the digital read out display 170 may be presented based on user preferences or settings.

Caliper 130 may be any type of measurement tool that is configured to measure the distance between two opposite sides of an object, thickness, distances, or internal and external diameters of objects.

In operation, the infill depth testing device 100 may be configured to be lifted by the handle 110 and placed over an artificial turf surface, holding the infill depth testing device 100 such that a bottom surface (see FIG. 2A and FIG. 2B) of the pin flange 160 is parallel with and touching a top surface of the artificial turf. Pushing down on the handle 110 while maintaining the infill depth testing device 100 in the upright position to engage the pins into the turf (e.g., the pins extending in a distal direction parallel to the pin flange 160). The weight flange 140 and the pin flange 160 may slide up the shaft 120 in a parallel direction as the pins extend in the distal direction. Continue pushing the infill depth testing device 100 into the artificial turf until the pins have reached to the bottom surface of the turf. The caliper 130 may then take a depth measurement, corresponding to the extended length of the pins 210 (see FIG. 2A and FIG. 2B) to be displayed on the digital read out display 170.

FIG. 1B depicts an exemplary turf infill depth tester, according to one or more embodiments. Infill depth testing device 100 may include components as depicted in FIG. 1A, but for brevity similarities will not be repeated. Infill depth testing device 100 may include a weight 155. The weight 155 may be located on the weight mount 150 of the weight flange 140. In operation, the weight 155 may be added to the infill depth testing device 100 prior to calibration. In order to calibrate the infill depth testing device 100, the infill depth testing device 100 may be placed on known flat surface (e.g., ground, cement, table, etc.) with or without the weight 155 to zero out the caliper 130 and digital read out display 170. Once calibrated, the infill depth testing device 100 may be ready for use.

FIG. 2A depicts a component of an exemplary turf infill depth tester, according to one or more embodiments. Infill depth testing device 100 may include components as described with reference to FIG. 1A and FIG. 1B, but for brevity similarities will not be repeated. The weight flange 140 may include the weight mount 150, and the pin flange 160. The weight mount 150 may be configured to hold at least one weight. For example, the weight mount 150 may be configured to hold at least one weight (e.g., Olympic-sized weight having a hole diameter of about 50 mm). The Olympic-sized weight is an example, any weight fitting the weight mount 150 may be used. In addition, the weight mount 150 may be configured to different diameters based on the types of weights intended for use. Adding weights to the weight mount 150 may allow the weight flange 140 to push the pin flange 160 into the turf to get more compacted readings. For example, the compacted reading is determined based on the amount the weight flange 140 moves relative to the caliper 130. The amount of movement of the weight flange 140 is determined based on the movement from the starting point (e.g., atop a turf surface) to an end point (e.g., a top surface of the infill). The ratio of the unweighted to weighted infill depth may assist in describing the compaction of infill depending on the amount of weight used.

Pin flange 160 may include pins 210. As shown, three pins 210 are displayed, however more or less pins 210 may be used. The pins 210 of the pin flange 160 work in conjunction with weight flange 140 to determine the infill depth measurement. The pins 210 are biased inside the pin flange 160 and are substantially recessed within the pin flange 160. When the weight flange 140 is placed atop a surface of the turf, a bottom surface 220 of the pin flange 160 is parallel with and touching the surface of the artificial turf. In operation, when the infill depth testing device 100 is pressed into the turf, the pins 210 extend into the artificial turf until they reach the infill. As the pins 210 extend, the weight flange 140 moves in a parallel direction to the caliper 130, thereby determining an infill depth measurement. The infill depth measure is based on the amount or length of the pins 210 that have extended from the pin flange 160 into the artificial turf with the pins 210 touching the infill.

FIG. 2B depicts an exemplary turf infill depth tester, according to one or more embodiments. Infill depth testing device 100 may include components as depicted in FIG. 2A, but for brevity similarities will not be repeated. Infill depth testing device 100 may include a weight 155. The weight 155 may be located on the weight mount 150 of the weight flange 140. As described above, the weight 155 may be added prior to calibration and operation of the infill depth testing device 100. The addition of the weight 155 may allow for a determination of compactness of the infill of the artificial turf. In operation, the infill depth testing device 100 may be used without the weight 155 to determine a first depth infill measurement (e.g., unweighted measurement). The weight 155 may be added and the measurement may be performed again to get a second infill depth measurement (e.g., weighted measurement). A ratio is determined between the first infill depth measurement and the second infill depth measurement to determine the compactness of the infill at the specified location. This process may be repeated at each location.

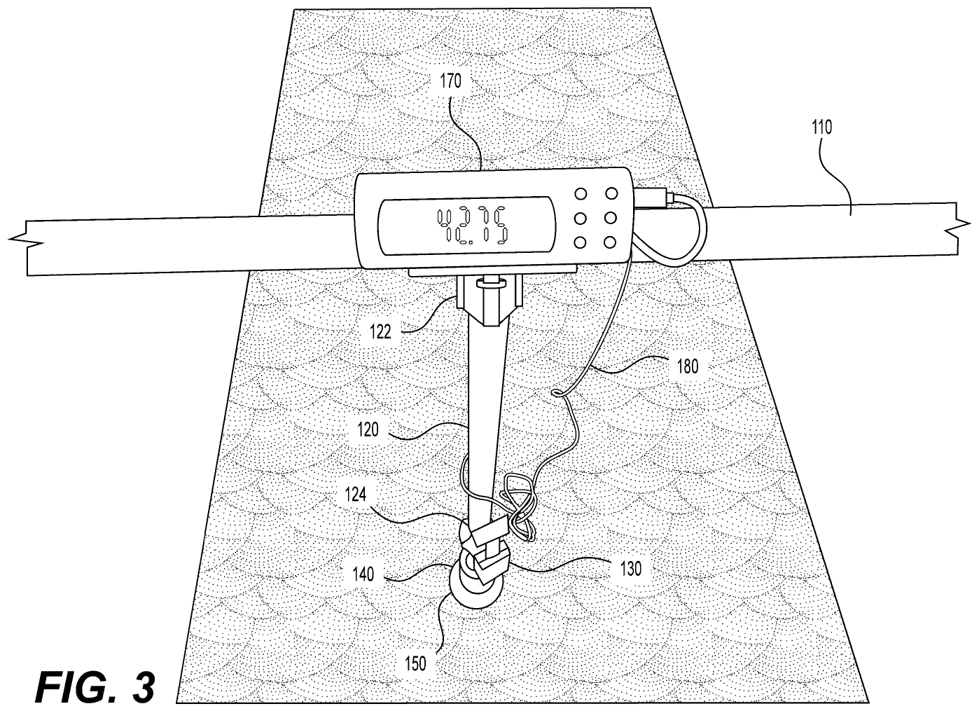

FIG. 3 depicts a top view of an exemplary turf infill depth tester, according to one or more embodiments. Infill depth testing device 100 may include all of the components as described with reference to FIG. 1A and FIG. 1B, but for brevity similarities will not be repeated. The digital read out display 170 may be configured to display a turf infill measurement received from the caliper 130. As shown the digital read out display 170 displays the infill measurement in millimeters (mm). However, as discussed above, the digital read out display 170 may be configured to display the infill depth measurement using either metric unites (e.g., millimeters) or imperial units (e.g., inches). The notification may be used to alert a user (e.g., visual and/or audible) to the infill depth measurement being outside the predefined range. Additional notifications from the digital read out display 170 may be presented based on user preferences or settings.

For example, the infill depth testing device 100 may be held by the handle 110 in an upright position, as displayed, with bottom surface 220 of the pin flange 160 touching the top of the turf. Using a downward force on the handle 110 of the infill depth testing device 100, the pins 210 extend into the artificial turf until the pins 210 reach the infill. As the pins 210 extend, the weight flange 140 moves in a parallel direction to the caliper 130, thereby determining an infill depth measurement. The infill depth measure is based on the amount or length of the pins 210 that have extended from the pin flange 160 into the artificial turf with the pins 210 touching the infill. The infill measurement determined by the caliper 130 may then be displayed on the digital read out display 170.

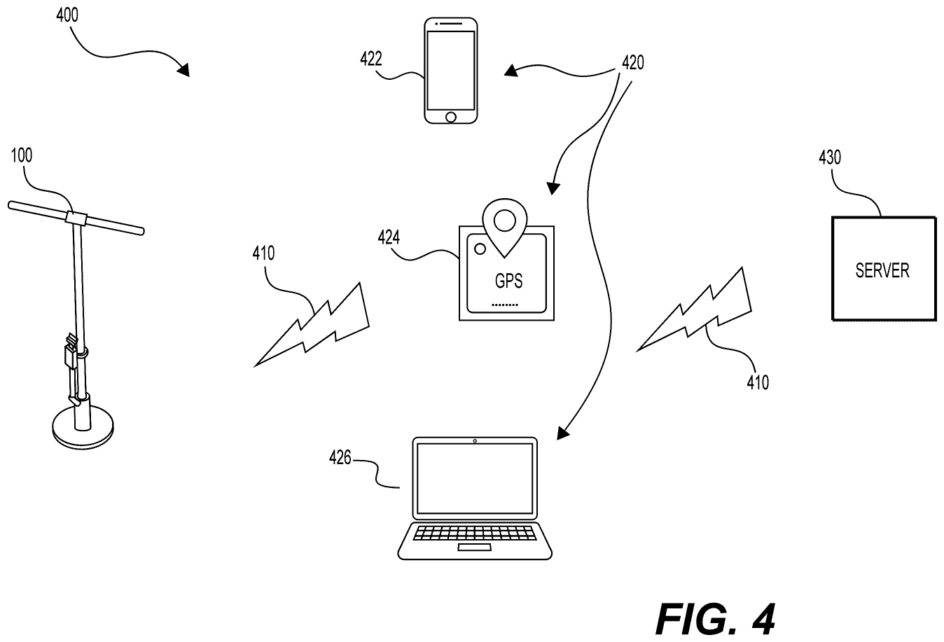

FIG. 4 depicts an exemplary system for use with a turf infill depth tester, according to one or more embodiments. System 400 may include infill depth testing device 100, connection 410, mobile device 420, and server 430. The infill depth testing device 100 may be similar to the infill depth tester as described with reference to any of FIG. 1-3. Connection 410 may include at least one of a wired or wireless connection. Wired connections may include, but are not limited to, one or more wires, Ethernet, fiber optics, coaxial cables, etc. Wireless connections may include, but are not limited to, Bluetooth®, Wi-Fi, infrared, Wireless WAN, etc. The mobile device 420 may include at least one of a mobile phone 422, a global positioning system (GPS) 424 device, or a laptop computer 426. Additional types of mobile devices, such as tablets, personal digital assistants (PDA), smart phones, etc., may be considered and used. The mobile device 420 may include a GPS software application. The server 430 may include one or more servers. The server 430 may be part of or separate from the mobile device 420. The server 430 may be a local server or a remote server (e.g., cloud server).

For example, the infill depth testing device 100 may be configured to determine an infill depth measurement. The digital read out display 170 may be in communication with the mobile device 420 to transmit the infill depth measurement to the mobile device 420. The mobile device 420 may be configured to display and/or store the infill depth measurement. The mobile device 420 may be in communication with the server 430 to transmit the infill depth measurement for storage.

In some embodiments, the infill depth testing device 100 may omit the digital read out display 170 and utilize the mobile device 420. For example, the infill depth testing device 100 may be configured to determine an infill depth measurement, and the connection 180 may transmit the infill depth measurement directly to the mobile device 420. The mobile device 420 may similarly be configured to display and/or store the infill depth measurement. In addition, the mobile device 420 may be in communication with the server 430 to transmit the infill depth measurement for storage.

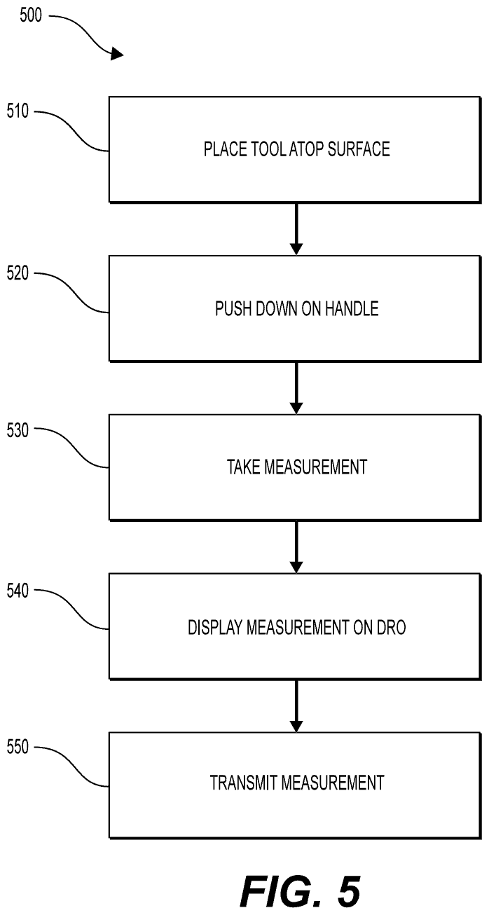

FIG. 5 depicts a flow diagram of an exemplary method 500 for using a turf infill depth tester, such as infill depth testing device 100, according to one or more embodiments. Method 500 may measure the depth of infill in artificial turf with or without the use of weights. Prior to performing the steps of method 500, calibration of the infill depth testing device 100 may be performed. To calibrate the infill depth testing device 100, the infill depth testing device 100 may be lifted by the handle 110 to a vertical or an about vertical position. Upon the infill depth testing device in the vertical position, the infill depth testing device 100 may be placed on a known flat surface (e.g., ground, cement, table, etc.). In doing so, the caliper 130 may be zeroed out in order to give an accurate measurement during use. The calibration process may be performed before operation, during operation, or a combination thereof, such as before, during, or after any steps of method 500. Method 500, as described without using weights, may start at step 510 where the turf infill depth testing device 100 may be placed atop the top surface of artificial turf. For example, a user may lift the infill depth testing device 100 by the handle 110 and placed the infill depth testing device 100 over the turf surface. A user may hold the infill depth testing device 100 such that a bottom surface 220 of the pin flange 160 is parallel with and touching a top surface of the turf. At step 520, a user may push down on the handle 110 while maintaining the infill depth testing device 100 in the upright position to engage the pins 210 into the turf. While pushing down on the handle 110 of the infill depth testing device 100, the pins 210 may extend in a distal direction that is parallel to the pin flange 160.

Next, at step 530, the infill depth testing device 100 may take an infill depth measurement based on the distance or length the pins 210 extended from the pin flange 160. For example, upon pushing down on the handle 110 of the infill depth testing device 100, the pins 210 may extend from the pin flange 160. As the pins 210 extend from the pin flange 160, the weight flange 140 and the pin flange 160 may slide, in a parallel direction towards the first distal portion 122 of the shaft 120. A user may continue pushing the infill depth testing device 100 into the turf until the pins 210 have reached to the bottom surface of the turf (e.g., reached the infill). The caliper 130 may then take the infill depth measurement. The infill depth measurement may include the infill depth, and additional information such as one or more of GPS location information (e.g., GPS location, Cartesian coordinates, etc.), timestamps, etc. In addition, a user may place a weight (e.g., Olympic-sized weight) on the weight mount 150 of the weight flange 140, taking additional infill depth measurements as described in further detail below. The weighted infill depth measurement may be used to compare the unweighted and weighted infill depth measurements to determine a ratio of compactness of the infill at different locations. The ratio may be used to determine compactness of the infill over time as it relates to the specifications of the installation by the manufacturer.

Still referring to FIG. 5, at step 540, the digital read out display 170 may receive the infill depth measurement via the connection 180 from the caliper 130, and display the infill depth measurement. The connection 180 being at least one of a wired or wireless connection. Once received, the digital read out display 170 may display the infill depth measurement. The digital read out display 170 may display the infill depth measurement. Alternatively, each infill depth measurement may not be displayed, but transmitted to the mobile device 420 and/or the server 430 for display and/or storage. Upon completing all of the measurements within a defined area, the infill depth testing device 100 via the digital read out display 170 may transmit the collective infill depth measurements to the mobile device 420 and/or the server 430 for display and/or storage.

At step 550, the infill depth testing device 100 may transmit the infill depth measurement, such as to mobile device 420 and/or the server 430. The infill depth testing device 100 may be configured to transmit each infill depth measurement or transmit a collection or collective set of infill depth measurements. A collection or collective set of infill depth measurements may include all or a portion of the infill depth measurements within a predetermined area (e.g., entire football field, one end zone, etc.). The transmission may occur directly from the infill depth testing device 100 or upon placement of the digital read out display 170 on a docking station (not shown). Each infill depth measurement and/or the collective set of infill depth measurements may be used to generate a graphic representation of the area measured. For individual measurements, the infill depth measurement may display at least one of the numerical value measured, the compactness of the infill, graph or heat map displaying the numeric value and/or the compactness of the infill. For a collection of measurements, the infill depth measurements may be displayed as a series of numerical values, a series of compactness values of the infill, a graph or heat map displaying the series of numeric values and/or the compactness of the infill, or the average with a corresponding graphic. The graphic representation may allow for determining the amount of infill be added or removed from any one or more locations based on the artificial turf's manufacturer specification requirements. After the infill depth measurement(s) have been transmitted and received be the mobile device 420 and/or server 430, the method 500 may be repeated as necessary.

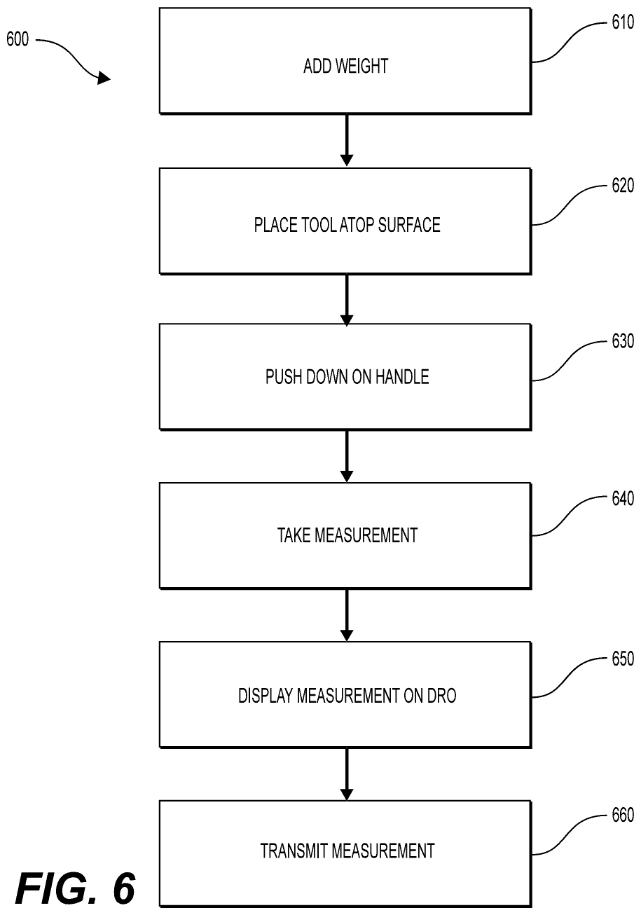

FIG. 6 depicts a flow diagram of an exemplary method 600 for using a turf infill depth tester, such as infill depth testing device 100, according to one or more embodiments. Prior to performing the steps of method 600, calibration of the infill testing depth device 100 may be performed. To calibrate the infill depth testing device 100, the infill depth testing device 100 may be lifted by the handle 110 to a vertical or an about vertical position. Upon the infill depth testing device in the vertical position, the infill depth testing device 100 may be placed on a known flat surface (e.g., ground, cement, table, etc.). In doing so, the caliper 130 may be zeroed out in order to give an accurate measurement during use. The calibration process may be performed before operation, during operation, or a combination thereof, such as before, during, or after any step in method 600. Method 600, as described using weights to determine a weighted (e.g., compactness) infill depth measurement, may start at step 610 where the user may add one or more weights 155 to the weight flange 140 via the weight mount 150. The number of weights and/or the weight may alter the infill depth measurement in determining the compactness value of the infill. Next, at step 620, the turf infill depth testing device 100 may be placed atop the top surface of artificial turf. For example, a user may lift the infill depth testing device 100 by the handle 110 and placed the infill depth testing device 100 over the turf surface. A user may hold the infill depth testing device 100 such that a bottom surface 220 of the pin flange 160 is parallel with and touching a top surface of the turf. At step 630, a user may push down on the handle 110 while maintaining the infill depth testing device 100 in the upright position to engage the pins 210 into the turf. While pushing down on the handle 110 of the infill depth testing device 100, the pins 210 may extend in the distal direction that is parallel to the pin flange 160.

Next, at step 640, the infill depth testing device 100 may take a compactness infill depth measurement based on the distance or length the pins 210 extended from the pin flange 160. For example, upon pushing down on the handle 110 of the infill depth testing device 100, the pins 210 may extend from the pin flange 160. As the pins 210 extend from the pin flange 160, the weight flange 140 and the pin flange 160 may slide, in a parallel direction towards the first distal portion 122 of the shaft 120. A user may continue pushing the infill depth testing device 100 into the turf until the pins 210 have reached to the bottom surface of the turf (e.g., the surface of the infill). The caliper 130 may then take a compactness infill depth measurement. The infill depth measurement may include the compactness infill depth, GPS location information (e.g., GPS location, Cartesian coordinates, etc.), timestamps, etc. The unweighted and weighted infill depth measurements may be used to determine the compactness of the infill at different locations. To determine compactness of the infill, the unweighted and the weighted infill depth measurements may be used to determine a ratio between the unweighted and weighted infill depth measurements. The ratio may be used to determine compactness of the infill over time as it relates to the specifications of the installation by the manufacturer. Based on the ratio between the unweighted and weighted infill depth measurements, it may be determined that either a tamping process is required, a decompaction process is required, or a combination thereof.

Still referring to FIG. 6, at step 650, the digital read out display 170 may receive the compactness infill depth measurement via the connection 180 from the caliper 130, and display the infill depth measurement. The connection 180 being at least one of a wired or wireless connection. Once received, the digital read out display 170 may display the compactness infill depth measurement. Alternatively, each compactness infill depth measurement may not be displayed, but transmitted to the mobile device 420 and/or the server 430 for display and/or storage. Upon completing all of the measurements within a defined area, the infill depth testing device 100 via the digital read out display 170 may transmit the collective compactness infill depth measurements to the mobile device 420 and/or the server 430 for display and/or storage.

At step 660, the infill depth testing device 100 may transmit the compactness infill depth measurement, such as to mobile device 420 and/or the server 430. The infill depth testing device 100 may be configured to transmit each compactness infill depth measurement or transmit a collection or collective set of compactness infill depth measurements. A collection or collective set of compactness infill depth measurements may include all or a portion of the compactness infill depth measurements within a predetermined area. The transmission may occur directly from the infill depth testing device 100 or upon placement of the digital read out display 170 on a docking station (not shown). Each compactness infill depth measurement and/or the collective set of compactness infill depth measurements may be used to generate a graphic representation of the area measured. For individual measurements, the compactness infill depth measurement may display at least one of the numerical value measured, the compactness of the infill, graph or heat map displaying the numeric value and/or the compactness of the infill. For a collection of measurements, the compactness infill depth measurements may be displayed as a series of numerical values, a series of compactness values of the infill, a graph or heat map displaying the series of numeric values and/or the compactness of the infill, or the average with a corresponding graphic. The graphic representation may allow for determining the amount of infill be added or removed from any one or more locations based on the artificial turf's manufacturer specification requirements. After the compactness infill depth measurement(s) have been transmitted and received be the mobile device 420 and/or server 430, the method 600 may be repeated as necessary.

A person having ordinary skill in the art may perform the method 600 as described above using some or all of the steps described in the same or similar order, or a rearranged order, depending on the application without departing from a scope of this disclosure.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

The following clauses provide an exemplary configuration for a turf infill depth tester described above.
Clause 1. A device for turf infill depth testing, the device comprising: a shaft including a first distal portion and a second distal portion opposite the first distal portion; a handle extending from the shaft proximate the first distal portion of the shaft; a digital read out display proximate the first distal portion of the shaft; a caliper disposed at the second distal portion of the shaft; and a weight flange disposed at the second distal portion of the shaft and operatively connected to the caliper, wherein the weight flange is configured to move in a direction parallel to the shaft and the caliper.
Clause 2. The device of clause 1, wherein the weight flange further includes: a weight mount configured to hold at least one weight; and a pin flange including a plurality of pins extending in a direction parallel to the pin flange.
Clause 3. The device of clause 1, further includes: a connection operatively connected to the digital read out display and the caliper, wherein the connection is configured to transmit an infill depth measurement measured by the caliper to the digital read out display.
Clause 4. The device of clause 3, wherein the connection includes at least one of a wireless or a wired connection.
Clause 5. The device of clause 1, wherein the weight flange is configured to determine an infill depth measurement upon placement of the weight flange atop a surface while pushing down on the handle.
Clause 6. The device of clause 5, wherein the digital read out display is configured to display the infill depth measurement.
Clause 7. The device of clause 1, wherein one of the device, the digital read out display, or the caliper is configured to transmit the infill depth measurement.
Clause 8. A system comprising: one more computing devices in communication with at least one server; and a turf infill depth testing device including: a shaft including a first distal portion and a second distal portion opposite the first distal portion; a handle extending from the handle proximate the first distal portion of the shaft; a digital read out display proximate the first distal portion of the shaft; a caliper disposed at the second distal portion of the shaft; and a weight flange disposed at the second distal portion of the shaft and operatively connected to the caliper.
Clause 9. The system of clause 8, wherein the one or more computing devices includes at least one of a mobile phone, a laptop computer, a personal digital assistant (PDA), or a global positioning system (GPS) device.
Clause 10. The system of clause 9, wherein the mobile phone, the laptop computer, or the personal digital assistant (PDA) includes a GPS software application.
Clause 11. The system of clause 10, wherein the GPS software application is configured to associate one or more infill depth measurements from the digital read out display with location information.
Clause 12. The system of clause 8, wherein the one or more computing devices are configured to display one or more readings from the digital read out display, wherein the one or more readings includes one of an infill depth measurement, a weighted infill depth measurement, or a coordinate value.
Clause 13. The system of clause 12, wherein the coordinate value includes at least one of a GPS location or a Cartesian coordinate value.
Clause 14. The system of clause 8, wherein the at least one server is configured to store one or more readings from the digital read out display either locally or remote from the one or more computing devices.
Clause 15. A method for determining an infill depth measurement, the method comprising: placing, by a user, an infill depth testing device atop a surface of artificial turf; pushing down, by the user, on a handle of the infill depth testing device; determining, by the infill depth testing device, an infill depth measurement; displaying, by the infill depth testing device, the infill depth measurement; and transmitting, by the infill depth testing device, to one or more computing devices the infill depth measurement for storage.
Clause 16. The method of clause 15, wherein the determining the infill depth measurement further includes: determining a movement distance of a weight flange and a pin flange of the infill depth testing device relative to a caliper.
Clause 17. The method of clause 16, wherein the caliper determines the infill depth measurement based on the movement distance of the weight flange and the pin flange.
Clause 18. The method of clause 15, wherein transmitting the infill depth measurement further includes receiving, by one or more computing devices, the infill depth measurement for display.
Clause 19. The method of clause 15, wherein the infill depth measurement includes one of an infill depth measurement, a weighted infill depth measurement, a coordinate value, or a timestamp.
Clause 20. The method of clause 15, wherein placing the infill depth testing device atop the surface includes placing a bottom surface of a pin flange parallel with and touching a top surface of artificial turf.

What is claimed is:

1. A device for turf infill depth testing, the device comprising:
a shaft including a first distal portion and a second distal portion opposite the first distal portion;
a handle extending from the shaft proximate the first distal portion of the shaft;
a digital read out display proximate the first distal portion of the shaft;
a caliper disposed at the second distal portion of the shaft; and
a weight flange disposed at the second distal portion of the shaft and operatively connected to the caliper, wherein the weight flange is configured to move in a direction parallel to the shaft and the caliper.

2. The device of claim 1, wherein the weight flange further includes:
a weight mount configured to hold at least one weight; and
a pin flange including a plurality of pins extending in a direction parallel to the pin flange.

3. The device of claim 1, further includes:
a connection operatively connected to the digital read out display and the caliper, wherein the connection is configured to transmit an infill depth measurement measured by the caliper to the digital read out display.

4. The device of claim 3, wherein the connection includes at least one of a wireless or a wired connection.

5. The device of claim 1, wherein the weight flange is configured to determine an infill depth measurement upon placement of the weight flange atop a surface while pushing down on the handle.

6. The device of claim 5, wherein the digital read out display is configured to display the infill depth measurement.

7. The device of claim 3, wherein one of the device, the digital read out display, or the caliper is configured to transmit the infill depth measurement.

8. A system comprising:
one more computing devices in communication with at least one server; and
a turf infill depth testing device including:
a shaft including a first distal portion and a second distal portion opposite the first distal portion;
a handle extending from the handle proximate the first distal portion of the shaft;
a digital read out display proximate the first distal portion of the shaft;
a caliper disposed at the second distal portion of the shaft; and
a weight flange disposed at the second distal portion of the shaft and operatively connected to the caliper.

9. The system of claim 8, wherein the one or more computing devices includes at least one of a mobile phone, a laptop computer, a personal digital assistant (PDA), or a global positioning system (GPS) device.

10. The system of claim 9, wherein the mobile phone, the laptop computer, or the personal digital assistant (PDA) includes a GPS software application.

11. The system of claim 10, wherein the GPS software application is configured to associate one or more infill depth measurements from the digital read out display with location information.

12. The system of claim 8, wherein the one or more computing devices are configured to display one or more readings from the digital read out display,
wherein the one or more readings includes one of an infill depth measurement, a weighted infill depth measurement, or a coordinate value.

13. The system of claim 12, wherein the coordinate value includes at least one of a GPS location or a Cartesian coordinate value.

14. The system of claim 8, wherein the at least one server is configured to store one or more readings from the digital read out display either locally or remote from the one or more computing devices.

15. A method for determining an infill depth measurement, the method comprising:
placing, by a user, an infill depth testing device atop a surface of artificial turf;
pushing down, by the user, on a handle of the infill depth testing device;
determining, by the infill depth testing device, an infill depth measurement;
displaying, by the infill depth testing device, the infill depth measurement; and
transmitting, by the infill depth testing device, to one or more computing devices the infill depth measurement for storage.

16. The method of claim 15, wherein the determining the infill depth measurement further includes: determining a movement distance of a weight flange and a pin flange of the infill depth testing device relative to a caliper.

17. The method of claim 16, wherein the caliper determines the infill depth measurement based on the movement distance of the weight flange and the pin flange.

18. The method of claim 15, wherein transmitting the infill depth measurement further includes receiving, by one or more computing devices, the infill depth measurement for display.

19. The method of claim 15, wherein the infill depth measurement includes one of an infill depth measurement, a weighted infill depth measurement, a coordinate value, or a timestamp.

20. The method of claim 15, wherein placing the infill depth testing device atop the surface includes placing a bottom surface of a pin flange parallel with and touching a top surface of artificial turf.
